(19) United States
(12) Patent Application Publication
(10) Pub. No.: US 2015/0142235 A1
(43) Pub. Date: May 21, 2015

(54) VIBRATION DAMPING CONTROL APPARATUS

(71) Applicants: Koji Miwa, Toyota-shi (JP); Takashi Kawai, Toyota-shi (JP)

(72) Inventors: Koji Miwa, Toyota-shi (JP); Takashi Kawai, Toyota-shi (JP)

(73) Assignee: TOYOTA JIDOSHA KABUSHIKI KAISHA, Toyota-shi (JP)

(21) Appl. No.: 14/402,517

(22) PCT Filed: May 21, 2012
(86) PCT No.: PCT/JP2012/062954

§ 371 Date: Jan. 28, 2015

(51) Int. Cl. B60W 30/20; B60K 6/26; H02P 6/10; B60W 20/00

(52) U.S. Cl. CPC B60W 30/20; B60W 20/00; B60K 6/26; H02P 6/10; B60W 2030/206
USPC 701/22; 318/400.23; 180/65.285

(57) ABSTRACT

A vibration damping control apparatus is mounted on a hybrid vehicle provided with an engine and a motor generator connected to the engine. The vibration damping control apparatus is a vibration damping control apparatus configured to control the motor generator to generate vibration damping torque which suppresses vibration of the hybrid vehicle. The vibration damping control apparatus is provided with: a gain correction value controlling device configured to change a gain correction value associated with the vibration damping torque, for each crank angle immediately before compression torque is generated in the engine, or for each crank angle at which the compression torque is zero.

### TECHNICAL FIELD

The present invention relates to a vibration damping control apparatus configured to suppress vibration caused by an engine operation or the like, in a vehicle such as, for example, a hybrid vehicle provided with an engine and a motor.

### BACKGROUND ART

As this type of apparatus, for example, there is proposed an apparatus in which torque pulsation caused by engine compression in the hybrid vehicle is attenuated by vibration damping torque by a motor generator. In particular, here, there is proposed a technology of changing a gain value of the vibration damping torque according to the number of engine revolutions (refer to Patent literature 1).

Alternatively, there is also proposed an apparatus in which correction is performed such that a gain is minimized at a top dead center according to a crank angle when torque for cancelling compression torque of the engine is outputted from the motor generator in the hybrid vehicle (refer to Patent literature 2).

Alternatively, there is also proposed an apparatus in which a rotational vibration suppression control gain is calculated according to a cylinder internal pressure when the engine is started by the motor in the hybrid vehicle, and in which rotation start suppression torque of the motor is adjusted (refer to Patent literature 3).

### CITATION LIST

### Patent Literature

Patent Literature 1: Japanese Patent No. 3958220
Patent Literature 2: Japanese Patent Application Laid Open No. 2009-214816
Patent Literature 3: Japanese Patent Application Laid Open No. 2007-291898

### SUMMARY OF INVENTION

### Technical Problem

According to the aforementioned Background Art, however, there is a possibility that the vibration generated in the vehicle cannot be sufficiently suppressed, which is technically problematic.

It is therefore an object of the present invention to provide a vibration damping control apparatus configured to preferably suppress the vibration generated in the vehicle.

### Solution to Problem

The above object of the present invention can be achieved by a vibration damping control apparatus mounted on a hybrid vehicle provided with an engine and a motor generator connected to the engine, and configured to control the motor generator to generate vibration damping torque which suppresses vibration of the hybrid vehicle, said vibration damping control apparatus is provided with: a gain correction value controlling device configured to change a gain correction value associated with the vibration damping torque, for each crank angle immediately before compression torque is generated in the engine, or for each crank angle at which the compression torque is zero.

According to the vibration damping control apparatus of the present invention, the vibration damping control apparatus is mounted on the hybrid vehicle provided with the engine and the motor generator connected to the engine. The motor generator may be connected to the engine, for example, via a member such as a damper. The motor generator is typically a motor generator for engine control, but may be a motor generator for driving the hybrid vehicle.

The vibration damping control apparatus controls the motor generator to generate the vibration damping torque which suppresses the vibration of the hybrid vehicle.

The gain correction value controlling device, which is provided, for example, with a memory, a processor and the like, changes the gain correction value associated with the vibration damping torque, for each crank angle immediately before the compression torque is generated in the engine, or for each crank angle at which the compression torque is zero.

The gain correction value is determined according to the number of revolutions of the engine. The gain correction value controlling device determines the gain correction value according to the number of revolutions of the engine at a timing of the crank angle immediately before the compression torque is generated, or at a timing of the crank angle at which the compression torque is zero, and changes the previously determined gain correction value to the currently determined gain correction value.

Here, the “crank angle immediately before the compression torque is generated in the engine” is, for example, a crank angle corresponding to a timing at which an intake valve is open in at least one of a plurality of cylinders of the engine (i.e. intake valve close (IVC)), or the like. The “crank angle at which the compression torque is zero” is, for example, a crank angle at which a piston reaches a top dead center in at least one of the plurality of cylinders of the engine, or the like.

According to the study of the present inventors, the following matter has been found. In the vibration damping control, the vibration damping gain is determined according to the number of revolutions of the engine in many cases. The number of revolutions of the engine varies little by little due to the compression torque. In particular, the number of revolutions is relatively low at the start of the engine, and thus, there is a relatively large influence of the compression torque. Therefore, if the vibration damping gain is changed at all times according to the number of revolutions of the engine, then, the vibration damping torque originally required is not generated, which possibly does not allow the suppression of the vibration of the vehicle, or which possibly increases the vibration of the vehicle.

In the present invention, however, as described above, the gain correction value associated with the vibration damping torque is changed by the gain correction value controlling device, for each crank angle immediately before the compression torque is generated in the engine, or for each crank angle at which the compression torque is zero. In other words, the gain correction value is changed, according to the number of revolutions of the engine when the number of revolutions of the engine is not influenced by the compression torque.

Then, if the motor generator is controlled to generate the vibration damping torque according to the gain correction value changed at the current timing of the crank angle immediately before the compression torque is generated, from the current crank angle immediately before the compression torque is generated to a next crank angle immediately before the compression torque is generated, instead of the vibration damping gain determined according to the number of revolutions of the engine, then, there is no influence of the compression torque. Alternatively, if the motor generator is controlled to generate the vibration damping torque according to the gain correction value changed at the current timing of the crank angle at which the compression torque is zero, from the current crank angle at which the compression torque is zero to a next crank angle at which the compression torque is zero, then, there is no influence of the compression torque. As a result, it is possible to preferably suppress the vibration generated in the hybrid vehicle.

The motor generator may be controlled (i) to generate the vibration torque according to the gain correction value changed at the current timing of the crank angle immediately before the compression torque is generated, from the current crank angle immediately before the compression torque is generated to the next crank angle at which the compression torque is zero, or (ii) to generate the vibration torque according to the gain correction value changed at the current timing of the crank angle at which the compression torque is zero, from the current crank angle at which the compression torque is zero to the next crank angle immediately before the compression torque is generated.

In one aspect of the vibration damping control apparatus of the present invention, wherein after changing the gain correction value, said gain correction value controlling device maintains the changed gain correction value until a next crank angle immediately before the compression torque is generated, or until a next crank angle at which the compression torque is zero.

According to this aspect, it is possible to preferably suppress the vibration generated in the hybrid vehicle, relatively easily.

Alternatively, in another aspect of the vibration damping control apparatus of the present invention, wherein said gain correction value controlling device estimates a number of revolutions of the engine at a next crank angle immediately before the compression torque is generated, or at a next crank angle at which the compression torque is zero, and after changing the gain correction value, said gain correction value controlling device changes the changed gain correction value according to the estimated number of revolutions until the next crank angle immediately before the compression torque is generated, or until the next crank angle at which the compression torque is zero.

According to this aspect, it is possible to preferably suppress the vibration generated in the hybrid vehicle, relatively easily.

The expression “ . . . changes the changed gain correction value changes the changed gain correction value according to the estimated number of revolutions” means, for example, to change the gain correction value on the basis of a slope associated with a monotonic increase or a monotonic decrease under an assumption that the number of revolutions monotonically increases or monotonically decreases from the current number of revolutions of the engine to the estimated number of revolutions.

The “number of revolutions of the engine at the next crank angle immediately before the compression torque is generated” may be estimated, for example, on the basis of current cranking torque and the current number of revolutions of the engine.

In another aspect of the vibration damping control apparatus of the present invention, wherein said vibration damping control apparatus is further provided with a number-of-rotations detecting device configured to detect a number of engine revolutions which is a number of revolutions of the engine, and said vibration damping control apparatus controls the motor generator to generate the vibration damping torque according to the detected number of engine revolutions without using the gain correction value, if the detected number of engine revolutions is greater than a number of engine revolutions corresponding to a resonance frequency band associated with the engine.

According to this aspect, it is possible to prevent that the gain correction value, which can have a relatively large value, is unnecessarily maintained, which is extremely useful in practice.

In another aspect of the vibration damping control apparatus of the present invention, wherein said vibration damping control apparatus is further provided with a number-of-rotations detecting device configured to detect a number of engine revolutions which is a number of revolutions of the engine, and said vibration damping control apparatus controls the motor generator to generate the vibration damping torque according to the detected number of engine revolutions without using the gain correction value, if the detected number of engine revolutions becomes greater than a number of engine revolutions corresponding to a resonance frequency band associated with the engine and then corresponds to the number of engine revolutions corresponding to the resonance frequency band.

If the number of revolutions of the engine once exceeds the number of revolutions corresponding to the resonance frequency band associated with the engine and then again corresponds to the number of revolutions corresponding to the resonance frequency band, the number of revolutions of the engine relatively quickly becomes greater than the number of revolutions corresponding to the resonance frequency band in many cases, which has been found according to the study of the present inventors.

Thus, the control of the motor generator as described above can reduce a processing load associated with the vibration damping control apparatus or the like, which is extremely useful in practice.

The operation and other advantages of the present invention will become more apparent from embodiments explained below.

### BRIEF DESCRIPTION OF DRAWINGS

FIG. 1 is a schematic block diagram illustrating a schematic configuration of a hybrid vehicle in a first embodiment.

FIG. 2 are conceptual diagrams illustrating one example of vibration damping control in a comparative example.

FIG. 3 is a diagram illustrating a vibration damping control process in the first embodiment.

FIG. 4 is a diagram illustrating a vibration damping gain in the first embodiment.

FIG. 5 are conceptual diagrams illustrating one example of estimation of the number of engine revolutions in a modified example of the first embodiment.

FIG. 6 is a diagram illustrating a vibration damping gain in the modified example of the first embodiment.

FIG. 7 is a diagram illustrating a vibration damping control process in a second embodiment.

FIG. 8 is a diagram illustrating a vibration damping gain in the second embodiment.

FIG. 9 is a diagram illustrating another example of the vibration damping gain in the second embodiment.

FIG. 10 are conceptual diagrams illustrating one example of vibration damping control during steady rotation of the engine.

### DESCRIPTION OF EMBODIMENTS

Hereinafter, embodiments of the vibration damping control apparatus of the present invention will be explained with reference to the drawings.

### First Embodiment

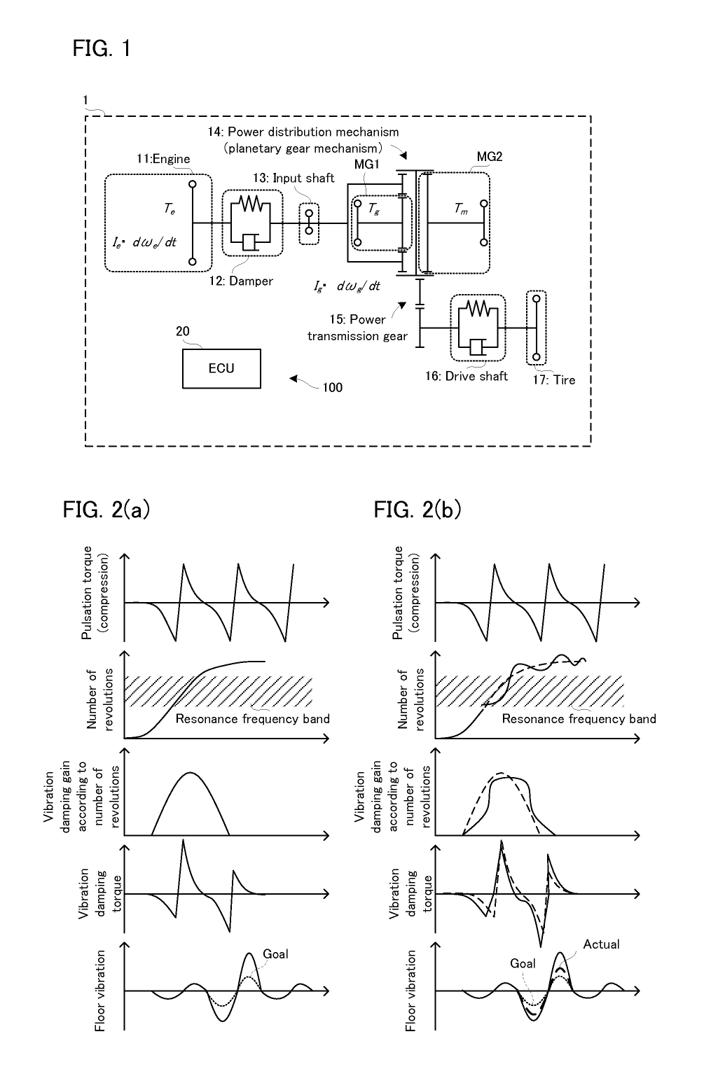

A first embodiment of the vibration damping control apparatus of the present invention will be explained with reference to FIG. 1 to FIG. 4.

### Vehicle Configuration

Firstly, a configuration of a hybrid vehicle in this embodiment will be explained with reference to FIG. 1. FIG. 1 is a schematic block diagram illustrating a schematic configuration of the hybrid vehicle in the first embodiment.

In FIG. 1, a hybrid vehicle 1 is provided with an engine 11, a damper 12, a power distribution mechanism 14, a motor generator MG1, a motor generator MG2, and an electronic control unit (ECU) 20.

A crankshaft of the engine 11 is connected to one end of the damper 12, and an input shaft 13 is connected to the other end of the damper 12.

The power distribution mechanism 14 is provided with a sun gear, a pinion gear, a carrier configured to support the pinion gear so that the pinion gear can rotate on its axis and can revolve, and a ring gear. The sun gear is configured to rotate integrally with a rotator of the motor generator MG1. The carrier is configured to rotate integrally with the input shaft 13.

A power output gear of the power distribution mechanism 14 transmits power to a power transmission gear 15 via a chain belt (not illustrated). The power transmitted to the power transmission gear 15 is transmitted to tires (or driving wheels) 17 via a drive shaft 16.

The ECU 20 controls the engine 11, the motor generator MG1 and the motor generator MG2 and the like, on the basis of output signals from, for example, a crank angle sensor (not illustrated), a resolver (not illustrated) configured to detect the number of revolutions of the motor generator MG1, a resolver (not illustrated) configured to detect the number of revolutions of the motor generator MG2, or the like.

A vibration damping control apparatus 100 is provided with the ECU 20. In the embodiment, namely, a part of the function of the ECU 20 for various electronic control of the hybrid vehicle 1 is used as a part of the vibration damping control apparatus 100.

Next, the balance of power in a power transmission system of the hybrid vehicle 1 will be explained. Here, the balance of power when the engine 11 starts will be explained.

Cranking torque (i.e. base torque) required for the motor generator MG1 is expressed by the following equation (1).

$$\begin{matrix}[ Equation 1 ] & \\ {T}_{g} = - \frac{ρ}{1 + ρ} \cdot {T}_{e} + {I}_{g} \cdot d {ω}_{g} / d t + \frac{ρ}{1 + ρ} \cdot {I}_{e} \cdot d {ω}_{e} / d t & ( 1 )\end{matrix}$$

wherein “T_{g}” is required cranking torque, “p” is a gear ratio, “Tₑ” is pulsating torque of the engine 11, “I_{g}” is inertia of the motor generator MG1, “dω_{g}/dt” is a rotational angular velocity of the motor generator MG1, “Iₑ” is inertia of the engine 11, and “dωₑ/dt” is a rotational angular velocity of the engine 11.

If the engine 11 and the motor generator MG1 operate ideally, the rotational angular velocity of the motor generator MG1 is expressed by the following equation (2).

$$\begin{matrix}[ Equation 2 ] & \\ d {ω}_{g} / d t = \frac{ρ}{1 + ρ} \cdot d {ω}_{e} / d t & ( 2 )\end{matrix}$$

If the equation (2) is substituted in the aforementioned equation (1), the required cranking torque T_{g} is expressed by the following equation (3).

$$\begin{matrix}[ Equation 3 ] & \\ {T}_{g} = \frac{ρ}{1 + ρ} \{ ( {I}_{e} + \frac{ρ}{1 + ρ} \cdot {I}_{e} ) \cdot d {ω}_{e} / d t - {T}_{e} \} & ( 3 )\end{matrix}$$

If the aforementioned equation (1) is arranged, ideal torque balance is expressed by the following equation (4).

$$\begin{matrix}[ Equation 4 ] & \\ {T}_{g} + \frac{ρ}{1 + ρ} \cdot {T}_{e} = {I}_{g} \cdot d {ω}_{g} / d t + \frac{ρ}{1 + ρ} \cdot {I}_{e} \cdot d {ω}_{e} / d t & ( 4 )\end{matrix}$$

In practice, however, the left side and the right side of the equation (4) do not balance each other, and excessive shaft torque is thus generated. The excessive shaft torque is expressed by the following equation (5).

$$\begin{matrix}[ Equation 5 ] & \\ {T}_{e , p} = ( {T}_{e} - {I}_{e} \cdot d {ω}_{e} / d t ) + \{ \frac{1 + ρ}{ρ} \cdot ( {T}_{g} - {I}_{g} \cdot d {ω}_{g} / d t ) \} & ( 5 )\end{matrix}$$

wherein “T_{e,ρ}” is the excessive shaft torque.

The vibration damping control apparatus 100 performs the vibration damping control by correcting the required cranking torque T_{g} such that the excessive shaft torque T_{e,ρ} becomes zero in the aforementioned equation (5).

### Comparative Example

Now, a vibration damping control process in a comparative example will be explained with reference to FIG. 2. FIG. 2 are conceptual diagrams illustrating one example of the vibration damping control in the comparative example.

In the vibration damping control process in the comparative example, a vibration damping gain is determined according to the current number of engine revolutions, and vibration damping torque is determined on the basis of the determined vibration damping gain. Then, required cranking torque of the motor generator is corrected by using the determined vibration damping torque.

If a variation in the number of engine revolutions caused by the compression torque of the engine is not considered, theoretically, for example, the vibration damping gain is determined as illustrated in the third graph from the top of FIG. 2(a), and the vibration damping torque is determined as illustrated in the fourth graph from the top of FIG. 2(a). Then, floor vibration is suppressed as illustrated in a dotted line in a lowest graph of FIG. 2(a).

Actually, however, as illustrated in a solid line in the second graph from the top of FIG. 2(b), there is the variation in the number of engine revolutions caused by the compression torque of the engine. Thus, if the vibration damping gain is determined according to the current number of revolutions, the vibration damping gain is as illustrated in a solid line in the third graph from the top of FIG. 2(b). As a result, there is a possibility that the floor vibration is not sufficiently suppressed as illustrated in a dashed line (refer to “actual”) in the lowest graph of FIG. 2(b).

### Vibration Damping Control Process

Therefore, the vibration damping control apparatus 100 in the embodiment is configured to determine the vibration damping gain of the vibration damping torque according to the number of revolutions of the engine 11 at a timing of a crank angle immediately before the compression torque is generated in the engine 11, or at a timing of a crank angle at which the compression torque is zero, and is configured to maintain the determined vibration damping gain until a next crank angle immediately before the compression torque is generated, or until a next crank angle at which the compression torque is zero.

Here, the “crank angle immediately before the compression torque is generated” is a crank angle corresponding to a timing at which an intake valve is open in at least one of a plurality of cylinders of the engine 11 (i.e. IVC) or the like. The “crank angle at which the compression torque is zero” is a crank angle at which a piston reaches a top dead center in at least one of a plurality of cylinders of the engine 11 (i.e. TDC) or the like.

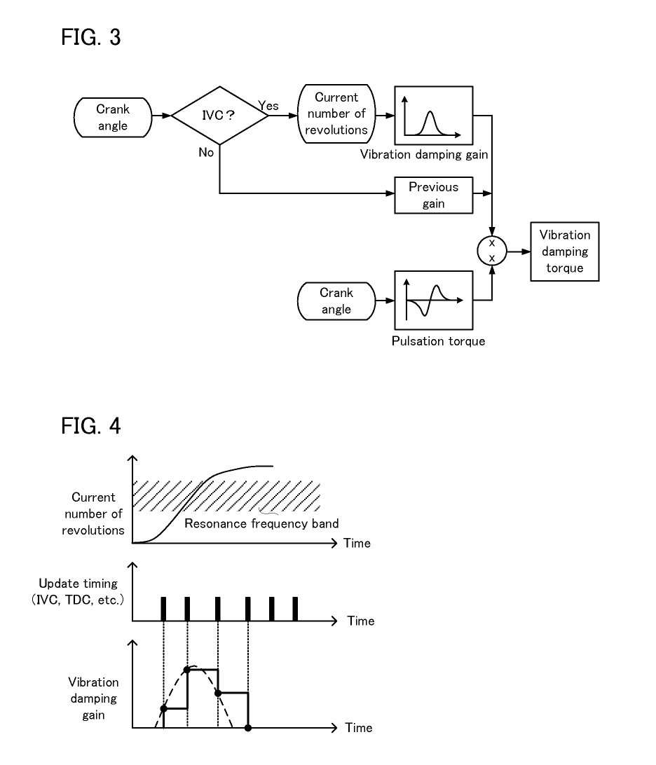

Next, a vibration damping control process performed by the vibration damping control apparatus 100 will be explained with reference to FIG. 3 and FIG. 4. FIG. 3 is a diagram illustrating the vibration damping control process in the first embodiment. FIG. 4 is a diagram illustrating the vibration damping gain in the first embodiment.

In FIG. 3, the ECU 20 as a part of the vibration damping control apparatus 100 obtains a current crank angle on the basis of the output signal of the crank angle sensor (not illustrated). The ECU 20 then determines whether or not the obtained crank angle is the IVC (incidentally, if the “TDC” is used instead of the “IVC”, the ECU 20 determines “whether or not the crank angle is the TDC”).

If it is determined that the crank angle is the IVC, the ECU 20 obtains the current number of revolutions of the engine 11, for example, on the basis of the output signal of the crank angle sensor. The ECU 20 then determines the vibration damping gain according to the obtained number of revolutions, and sets a gain correction value (corresponding to the “previous gain” in FIG. 3) to the determined vibration damping gain.

The ECU 20 then determines the vibration damping torque from the determined vibration damping gain and from pulsation torque determined on the basis of the crank angle. The “pulsation torque” means the sum of the compression torque of the engine 11 and reciprocating inertia torque of a piston system of the engine 11. Various known aspects can be applied to a method of calculating the pulsation torque, and thus, an explanation of the details thereof is omitted here.

On the other hand, if it is determined that the crank angle is not the IVC, the ECU 20 uses the vibration damping gain determined the last time the crank angle is determined to be the IVC (namely, the gain correction value), to determine the vibration damping torque.

The vibration damping gain determined as a result of the vibration damping control process described above is, for example, as illustrated in a solid line in the lowest graph of FIG. 4. In other words, the vibration damping gain is determined according to the number of revolutions of the engine 11 at the timing at which the crank angle is the IVC (refer to black circles in FIG. 4), and the determined vibration damping gain is maintained, regardless of the number of evolutions of the engine 11, until the next time the crank angle becomes the IVC.

As described above, in the embodiment, the vibration damping gain is not determined according to the actual number of revolutions of the engine 11 in a period in which the number of revolutions of the engine 11 varies due to the compression torque. It is therefore possible to determine the vibration damping gain without an influence of the number of revolutions of the engine 11 caused by the compression torque. As a result, it is possible to preferably suppress the vibration generated in the hybrid vehicle 1.

The “ECU 20” in the embodiment is one example of the “gain correction value controlling device” of the present invention.

### Modified Example

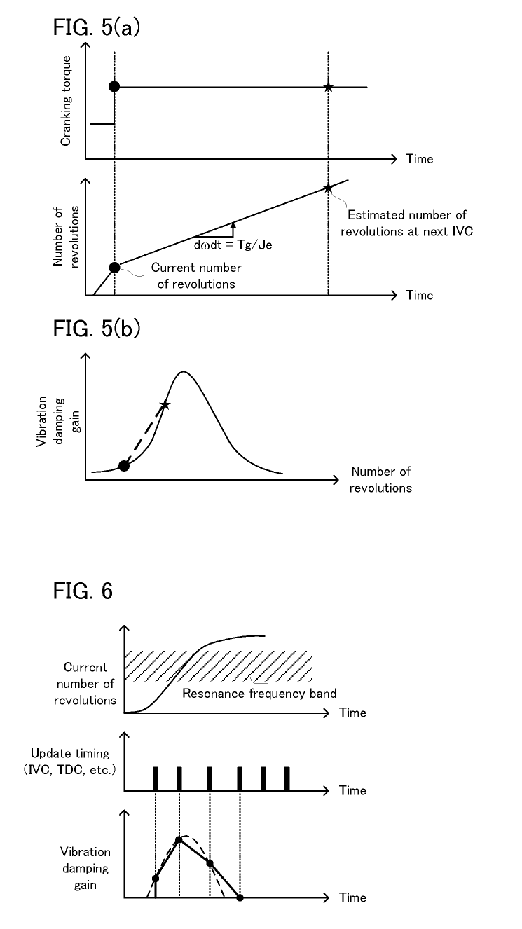

Next, a modified example of the first embodiment will be explained with reference to FIG. 5 and FIG. 6. In the modified example, the ECU 20 determines the vibration damping gain according to the number of revolutions of the engine 11, for example, at the timing at which the crank angle is the IVC, and estimates the number of revolutions of the engine 11 at the next timing at which the crank angle becomes the IVC on the basis of the number of revolutions of the engine 11. The ECU 20 then varies the currently determined vibration damping gain according to the estimated number of revolutions until the next time the crank angle reaches the IVC.

Specifically, for example, the ECU 20 obtains a rotational increasing rate d_{ω}/dt on the basis of a current cranking torque command value Tg (refer to a black circle in an upper graph of FIG. 5(a)) and an inertia value Je (default) of the engine 11.

The ECU 20 then estimates the number of revolutions at the next timing at which the crank angle becomes the IVC on the basis of the current number of revolutions of the engine 11 and the rotational increasing rate d_{ω}/dt (refer to a star mark in a lower graph of FIG. 5(a)).

In addition to the aforementioned method, various known aspects can be applied to the estimation of the number of revolutions of the engine 11. FIG. 5(a) illustrates a case where the cranking torque command value is constant; however, the number of revolutions of the engine 11 can be estimated even if the cranking torque command value varies.

The ECU 20 then obtains a rate of change of the vibration damping gain (i.e. a slope of a dashed line in FIG. 5(b)) on the basis of the current number of revolutions of the engine 11, the estimated number of revolutions, and a map indicating the vibration damping gain and the number of revolutions as illustrated in FIG. 5(b). The ECU 20 then changes the currently determined vibration damping gain until the next time the crank angle reaches the IVC, on the basis of the obtained rate of change of the vibration damping gain.

The vibration damping gain determined as a result of the vibration damping control process described above is, for example, as illustrated in a solid line in the lowest graph of FIG. 6. In other words, the vibration damping gain is determined according to the number of revolutions of the engine 11 at the timing at which the crank angle is the IVC (refer to the black circles in FIG. 4), and the determined vibration damping gain is changed on the basis of the rate of change of the vibration damping gain until the next time the crank angle becomes the IVC.

### Second Embodiment

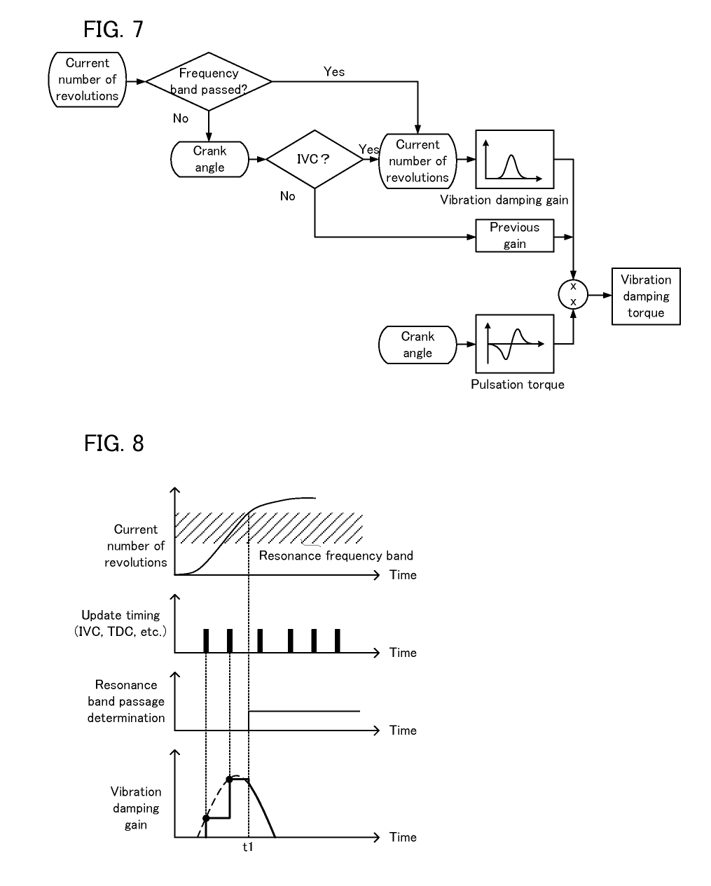

A second embodiment of the vibration damping control apparatus of the present invention will be explained with reference to FIG. 7 to FIG. 9. The second embodiment has the same configuration as that of the first embodiment, except for having a partially different vibration damping control process. Therefore, in the second embodiment, a duplication of the explanation in the first embodiment is omitted. Common portions on the drawing carry the same reference numerals, and only basically different points are explained with reference to FIG. 7 to FIG. 9. FIG. 7 is a diagram illustrating the vibration damping control process in the second embodiment, to the same effect as in FIG. 3.

In FIG. 7, the ECU 20 as a part of the vibration damping control apparatus 100 obtains the current number of revolutions of the engine 11 on the basis of the output signal of the crank angle sensor as one example of the “number-of-revolutions detecting device” of the present invention. The ECU 20 then determines whether or not the obtained number of revolutions exceeds a resonance frequency band associated with the engine 11.

If it is determined that the obtained number of revolutions exceeds the resonance frequency band associated with the engine 11, the ECU 20 determines the vibration damping gain according to the obtained number of revolutions. The ECU 20 then determines the vibration damping torque from the determined vibration damping gain and the pulsation torque.

On the other hand, if it is determined that the obtained number of revolutions does not exceed the resonance frequency band associated with the engine 11, the ECU 20 determines the vibration damping gain, for example, at the timing at which the crank angle is the IVC, and maintains the determined vibration damping gain until the next time the crank angle becomes the IVC, as in the first embodiment described above.

The vibration damping gain determined as a result of the vibration damping control process described above is, for example, as illustrated in a solid line in the lowest graph of FIG. 8. In other words, if it is determined that the number of revolutions of the engine 11 exceeds the resonance frequency band associated with the engine 11, the vibration damping gain is determined according to the number of revolutions of the engine 11 (refer to at or after a time point t1 in FIG. 6)

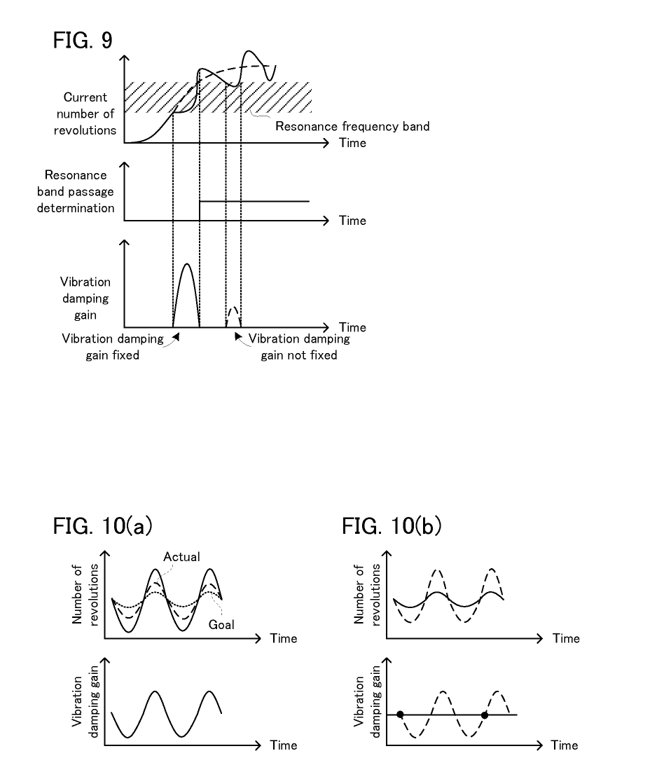

Particularly in the embodiment, if the number of revolutions of the engine 11 becomes the number of revolutions corresponding to the resonance frequency band again after it is once determined that the number of revolutions of the engine 11 exceeds the resonance frequency band (refer to FIG. 9), the ECU 20 determines the vibration damping gain according to the number of revolutions of the engine 11 (i.e. the vibration damping gain is not fixed).

The present invention can be also applied to the vibration damping control not only when the engine 11 starts, but also when the engine 11 stops or is during the steady rotation.

Specifically, for example, during the steady rotation of the engine 11, if no measures are taken, the vibration damping gain varies due to the variation in the number of revolutions of the engine caused by the compression torque, as illustrated in FIG. 10(a). It is thus hardly possible to sufficiently suppress the vibration generated in the hybrid vehicle 1. On the other hand, if the present invention is applied, the vibration damping gain can be set constant (the steady rotation theoretically allows the constant vibration damping gain) as illustrated in a lower graph of FIG. 10(b). It is thus possible to preferably suppress the vibration generated in the hybrid vehicle 1.

The present invention is not limited to the aforementioned embodiment, but various changes may be made, if desired, without departing from the essence or spirit of the invention which can be read from the claims and the entire specification. A vibration damping control apparatus, which involves such changes, is also intended to be within the technical scope of the present invention.

### DESCRIPTION OF REFERENCE NUMERALS AND LETTERS

1 hybrid vehicle
11 engine
12 damper
13 input shaft
14 power distribution mechanism
15 power transmission gear
16 drive shaft
17 tire
20 ECU
100 vibration damping control apparatus
MG1, MG2 motor generator

1. A vibration damping control apparatus mounted on a hybrid vehicle comprising an engine and a motor generator connected to the engine, and configured to control the motor generator to generate vibration damping torque which suppresses vibration of the hybrid vehicle, said vibration damping control apparatus comprising:
a gain correction value controlling device configured to change a gain correction value associated with the vibration damping torque, for each crank angle immediately before compression torque is generated in the engine, or for each crank angle at which the compression torque is zero.

2. The vibration damping control apparatus according to claim 1, wherein after changing the gain correction value, said gain correction value controlling device maintains the changed gain correction value until a next crank angle immediately before the compression torque is generated, or until a next crank angle at which the compression torque is zero.

3. (canceled)

4. The vibration damping control apparatus according to claim 1, wherein the crank angle at which the compression torque is zero is a crank angle at which a piston reaches a top dead center in at least one of a plurality of cylinders of the engine.

5. The vibration damping control apparatus according to claim 1, wherein the crank angle immediately before the compression torque is generated is a crank angle at which an intake valve is open in at least one of a plurality of cylinders of the engine.

6. The vibration damping control apparatus according to claim 1, wherein
said vibration damping control apparatus further comprises a number-of-rotations detecting device configured to detect a number of engine revolutions which is a number of revolutions of the engine, and
said vibration damping control apparatus controls the motor generator to generate the vibration damping torque according to the detected number of engine revolutions without using the gain correction value, if the detected number of engine revolutions is greater than a number of engine revolutions corresponding to a resonance frequency band associated with the engine.

7. The vibration damping control apparatus according to claim 1, wherein
said vibration damping control apparatus further comprises a number-of-rotations detecting device configured to detect a number of engine revolutions which is a number of revolutions of the engine, and
said vibration damping control apparatus controls the motor generator to generate the vibration damping torque according to the detected number of engine revolutions without using the gain correction value, if the detected number of engine revolutions becomes greater than a number of engine revolutions corresponding to a resonance frequency band associated with the engine and then corresponds to the number of engine revolutions corresponding to the resonance frequency band.

8. The vibration damping control apparatus according to claims 2, wherein the crank angle at which the compression torque is zero is a crank angle at which a piston reaches a top dead center in at least one of a plurality of cylinders of the engine.

9. The vibration damping control apparatus according to claims 2, wherein the crank angle immediately before the compression torque is generated is a crank angle at which an intake valve is open in at least one of a plurality of cylinders of the engine.

10. The vibration damping control apparatus according to claim 6, wherein
said vibration damping control apparatus further comprises a number-of-rotations detecting device configured to detect a number of engine revolutions which is a number of revolutions of the engine, and
said vibration damping control apparatus controls the motor generator to generate the vibration damping torque according to the detected number of engine revolutions without using the gain correction value, if the detected number of engine revolutions becomes greater than a number of engine revolutions corresponding to a resonance frequency band associated with the engine and then corresponds to the number of engine revolutions corresponding to the resonance frequency band.
